(19) United States
(12) Patent Application Publication
(10) Pub. No.: US 2010/0165429 A1
(43) Pub. Date: Jul. 1, 2010

(54) OPTICAL SYSTEMS

(75) Inventors: Edward Buckley, Cambridgeshire (GB); Diego Gil-Leyva, Cambridgeshire (GB)

Correspondence Address: KNOBBE MARTENS OLSON & BEAR LLP, 2040 MAIN STREET, FOURTEENTH FLOOR, IRVINE, CA, 92614, US

(73) Assignee: Light Blue Optics Ltd., Cambridge, Cambridgeshire (GB)

(21) Appl. No.: 12/593,601

(22) PCT Filed: Mar. 28, 2008
(86) PCT No.: PCT/GB2008/050224

§ 371 Date: Feb. 17, 2010

Related U.S. Application Data
(60) Provisional application No. 60/909,394, filed on Mar. 30, 2007.

(30) Foreign Application Priority Data
Mar. 30, 2007 (GB) 0706264.9

(51) Int. Cl. G03H 1/08; G03H 1/22

(52) U.S. Cl. 359/9; 359/14

(57) ABSTRACT

A holographic head up display (HUD) for a vehicle to display an image holographically on a curved display surface such as a windshield is disclosed. The HUD can include a spatial light modulator (SLM) to display a hologram, an illumination system to illuminate said displayed hologram, projection optics to project light from said hologram onto said display surface to form said image, and a processor configured to process said image data to generate hologram data for display on the SLM to form said image. The HUD can further include a non-volatile data memory coupled to said processor to store wavefront correction data for said display surface, and the processor can be configured to apply a wavefront correction responsive to said stored wavefront correction data when generating the hologram data to correct the image for aberration due to a shape of said display surface.

### CROSS-REFERENCE TO RELATED APPLICATION

This application is the U.S. National Phase under 35 U.S.C. §371 of International Application No. PCT/GB2008/050224, filed Mar. 28, 2008, designating United States and published in English on Oct. 9, 2008, as WO 2008/120015, which claims priority to United Kingdom Application No. 0706264.9, filed on Mar. 30, 2007 and U.S. Provisional Patent Application No. 60/909,394, filed on Mar. 30, 2007.

### FIELD OF THE INVENTION

This invention relates to holographic head up displays (HUDs), in particular correcting for aberrations due to projection onto a curved display surface such as a windshield, and to related methods of displaying an image holographically and to corresponding processor control code.

### BACKGROUND TO THE INVENTION

We have previously described techniques for displaying an image holographically (see, for example, WO 2005/059660, WO 2006/134398, GB2429355 and WO 2006/134404, all hereby incorporated by reference in their entirety). The techniques we describe have advantages for vehicle head up displays but there are practical problems in their use, in particular because the image is generally formed on a curved surface such as a windshield. (In this specification windshield is used synonymously for windscreen). Further background prior art can be found in GB2,350,961.

### SUMMARY OF THE INVENTION

According to the present invention there is therefore provided a holographic head up display (HUD) for a vehicle to display an image holographically on a display surface of the vehicle, the HUD comprising: a spatial light modulator (SLM) to display a hologram; an illumination system to illuminate said displayed hologram; projection optics to project light from said illuminated displayed hologram onto said display surface to form said image; and a processor having an input to receive image data for display and having an output for driving said SLM, and wherein said processor is configured to process said image data to generate hologram data for display on said SLM to form said image on said display surface; said HUD further comprising a non-volatile data memory coupled to said processor to store wavefront correction data for said display surface; and wherein said processor is configured to apply a wavefront correction responsive to said stored wavefront correction data when generating said hologram data to correct said image for aberration due to a shape of said display surface.

In some preferred embodiments the wavefront correction data comprises phase data and the processor is configured to phase modulate the hologram data with the phase data. For example the wavefront correction data may comprise data defining a phase map of a portion of the display surface on which the image is to be displayed. It will be appreciated, however, that in embodiments the phase correction or compensation is applied in the hologram plane. The skilled person will understand that the correction for image aberrations due to a shape of the display surface need not be a perfect correction; in general the appropriate degree of correction will depend upon the desired spatial resolution of the displayed information.

In some preferred embodiments the hologram data is quantised, more particularly binarised, for driving the (binary phase) SLM. Again in some particularly preferred embodiments the image is generated using a plurality of temporal subframes each generated by displaying a corresponding hologram, the subframes averaging together in an observer's eye to give an overall impression of the desired image.

In embodiments at least a portion, for example a singlet lens, of the projection optics is encoded in the displayed hologram. This facilitates implementation of a compact optical system.

A head up display of the type described above may be employed in any type of vehicle including, but not limited to, an aircraft, automobile, lorry, and tank. In general, but not essentially, the display surface comprises a windshield of the vehicle.

In embodiments the holographic head-up display system performs both wavefront correction and image generation in the same (a single) holographic component. In embodiments the holographic head-up display system is provided as a “one size fits all” system; that is essentially the same system may be employed in a plurality of different vehicle types, for example different models of a car, simply by reprogramming the wavefront correction data. Alternatively wavefront correction data for a set of different windshield types may be stored and selected, say on installation, for example by programming or by a hardware modification such as a wire link.

Thus there is also provided a vehicle including a holographic head-up display system with a holographic component to perform simultaneously both wavefront correction and image generation, wherein the system is arranged to display an image on a curved surface of the vehicle, such as the windshield, and wherein the system is programmed with wavefront modification data for the curved display surface of the vehicle and to apply a corresponding wavefront correction prior to display of data on said holographic component such that, in use, a holographically generated image formed on said curved surface by said holographic component is automatically compensated for curvature of said display surface.

In a related aspect the invention provides a method of displaying an image holographically on a display surface, the method comprising: inputting image data defining said image for display; generating hologram data from said image data; using said hologram data to display said image; and wherein said generating of said hologram data further comprises correcting for an optical aberration due to a shape of said display surface.

In embodiments of the method the correcting comprising multiplying by a conjugate of a phase map of the display surface. As previously described, a portion of projection optics may be encoded into the hologram data. In some preferred embodiments the projection optics is configured to give the appearance of the image being at a greater distance from an observer (for example a pilot or driver) than the display surface—that is in some preferred embodiments the image appears further away than the windshield. An encoded lens of the projection optics preferably comprises a lens which, in a conventional configuration, would be adjacent the hologram and thus the lens may comprise, for example, part of collimation optics (a collimation lens) and/or a lens forming part of a beam expander or Keplerian telescope or a lens forming part of demagnification optics for enlarging the displayed image. In some embodiments multiple lenses may be encoded into the displayed hologram, for example in the case of an optical system comprising a reflective SLM (or an SLM and a reflector) in which light passes in opposite directions through the SLM, encoding what would otherwise be, in a non-reflective system, one lens to either side of the SLM.

Embodiments of the above-described method also provide the advantage, in the context of a manufacturer providing head up displays for a range of different vehicles, of not requiring an optical hardware re-design for each separate shape of display surface (windshield).

Thus in a further aspect the invention provides a method of providing a head up display for a plurality of different vehicles having a plurality of differently shaped display surfaces using common display hardware, the method comprising providing the head up display holographically, in particular as described above, and storing for each different shape of display surface wavefront correction data for use in generating a hologram which, when replayed, displays an image for the head up display.

There is a number of ways in which the wavefront correction data may be obtained. For example a wavefront sensor may be employed to determine aberration in a physical model of the optical system by employing a wavefront sensor such as a Shack-Hartman or interferogram-based wavefront sensor. More preferably, however, an optical modelling system such as ZEMAX or CODE 5 may be employed to model the optical system since ray tracking packages of this sort are generally able to provide output data defining optical aberrations in the system.

some particularly preferred embodiments the determining of the wavefront correction data uses Zernike polynomials or Seidel functions. These are particularly convenient because their basis functions (Zernike modes) correspond to common types of optical aberrations such as defocus, coma, spherical aberration (Z₁₁), astigmatism, and the like and thus these coefficients provide a particularly economical way of representing aberrations.

The invention still further provides a holographic image projection system to display an image holographically on a display surface, said display surface not being flat, the system comprising: a spatial light modulator (SLM) to display a hologram; an illumination system to illuminate said displayed hologram; projection optics to project light from said illuminated displayed hologram onto said display surface to form said image; and a processor having an input to receive image data for display and having an output for driving said SLM, and wherein said processor is configured to process said image data to generate hologram data for display on said SLM to form said image on said display surface; the system further comprising a non-volatile data memory coupled to said processor to store wavefront correction data for said display surface; and wherein said processor is configured to apply a wavefront correction responsive to said stored wavefront correction data when generating said hologram data to correct said image for aberration due to a shape of said display surface.

The invention also provides processor control code to implement the above-described methods, in particular on a data carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

### BRIEF DESCRIPTION OF THE DRAWINGS

FIG. 1 shows an example of a consumer electronic device incorporating a holographic projection module;

FIG. 2 shows an example of an optical system for the holographic projection module of FIG. 1;

FIG. 3 shows a block diagram of an embodiment of a hardware accelerator for the holographic image display system of FIGS. 1 and 2;

FIG. 4 shows the operations performed within an embodiment of a hardware block as shown in FIG. 3;

FIG. 5 shows the energy spectra of a sample image before and after multiplication by a random phase matrix.

FIG. 6 shows an embodiment of a hardware block with parallel quantisers for the simultaneous generation of two sub-frames from the real and imaginary components of the complex holographic sub-frame data respectively.

FIG. 7 shows an embodiment of hardware to generate pseudo-random binary phase data and multiply incoming image data, I_{xy}, by the phase values to produce G_{xy}.

FIG. 8 shows an embodiment of hardware to multiply incoming image frame data, by complex phase values, which are randomly selected from a look-up table, to produce phase-modulated image data, G_{xy};

FIG. 9 shows an embodiment of hardware which performs a 2-D transform on incoming phase-modulated image data, G_{xy}, by means of a 1-D transform block with feedback, to produce holographic data gᵤᵥ;

FIGS. 10a to 10c show, respectively, a conceptual diagram of an optical system according to an embodiment of the invention, and first and second examples of holographic image projection systems according to embodiments of the invention;

FIGS. 11a to 11e show, respectively, a Fresnel diffraction geometry in which a hologram h(x,y) is illuminated by coherent light, and an image H(u,v) is formed at a distance z by Fresnel (or near-field) diffraction, a Fourier hologram, a Fresnel hologram, a simulated replay field of a Fourier hologram, and a simulated replay field of a Fresnel hologram showing absence of a conjugate image from the diffracted near-field, in which the hologram pixels are 40 μm square, and the propagation distance z=200 mm;

FIG. 12 shows change in replay field size caused by a variable demagnification assembly of lenses L₃ and L₄ in which in a first configuration the demagnification is

$$D = \frac{{f}_{3}}{{f}_{4}}$$

with a corresponding replay field (RPF) size Rₘₐₓ in which in a second configuration the demagnification is

$$D = \frac{{f}_{3}}{{f}_{4}} ,$$

giving rise to a RPF of size R;

FIGS. 13a to 13c show experimental results for variable demagnification as illustrated in FIG. 12 for f₃=100 mm, f₃=200 mm, and f₃=400 mm respectively, in which the change in size of the replay field is determined by the focal length of lens L₃, which is encoded onto the hologram;

FIG. 14 shows an optical arrangement according to an embodiment of the invention for a lens-sharing projector design, utilizing a f=100 mm lens encoded onto a Fresnel hologram displayed on an SLM, in which (optional) polarisers have been are omitted for clarity;

FIG. 15 shows experimental results from the lens-sharing projector setup of FIG. 14, in which the demagnification caused by the combination of L₄ and the hologram has caused optical enlargement of the RPF by a factor of approximately three;

FIG. 16 shows a flow diagram of a procedure to implement a holographic head up display incorporating aberration correction for projecting a holographically displayed image onto a curved surface according to an embodiment of the invention;

FIGS. 17a and b show, respectively, a block diagram of a holographic head up image display system according to an embodiment of the invention, and an alternative optical configuration for the system of FIG. 17a; and

FIGS. 18a to 18d show, respectively, first and second holographic wavefront sensors using Zernike modes, a corresponding replay field illustrating effects of aberration, and a replay field of a hologram providing a phase conjugate correction for the replay field of FIG. 18c.

### DETAILED DESCRIPTION OF PREFERRED EMBODIMENTS

We have previously described, in UK patent application number 0512179.3 filed 15 Jun. 2005, incorporated by reference, a holographic projection module comprising a substantially monochromatic light source such as a laser diode; a spatial light modulator (SLM) to (phase) modulate the light to provide a hologram for generating a displayed image; and a demagnifying optical system to increase the divergence of the modulated light to form the displayed image. Absent the demagnifying optics the size (and distance from the SLM) of a displayed image depends on the pixel size of the SLM, smaller pixels diffracting the light more to produce a larger image. Typically an image would need to be viewed at a distance of several metres or more. The demagnifying optics increase the diffraction, thus allowing an image of a useful size to be displayed at a practical distance. Moreover the displayed image is substantially focus-free: that is the image is substantially in focus over a wide range or at all distances from the projection module.

A wide range of different optical arrangements can be used to achieve this effect but one particularly advantageous combination comprises first and second lenses with respective first and second focal lengths, the second focal length being shorter than the first and the first lens being closer to the spatial light modulator (along the optical path) than the second lens. Preferably the distance between the lenses is substantially equal to the sum of their focal distances, in effect forming a (demagnifying) telescope. In some embodiments two positive (i.e., converging) simple lenses are employed although in other embodiments one or more negative or diverging lenses may be employed. A filter may also be included to filter out unwanted parts of the displayed image, for example a bright (zero order) undiffracted spot or a repeated first order image (which may appear as an upside down version of the displayed image).

This optical system (and those described later) may be employed with any type of system or procedure for calculating a hologram to display on the SLM in order to generate the displayed image. However we have some particularly preferred procedures in which the displayed image is formed from a plurality of holographic sub-images which visually combine to give (to a human observer) the impression of the desired image for display. Thus, for example, these holographic sub-frames are preferably temporally displayed in rapid succession so as to be integrated within the human eye. The data for successive holographic sub-frames may be generated by a digital signal processor, which may comprise either a general purpose DSP under software control, for example in association with a program stored in non-volatile memory, or dedicated hardware, or a combination of the two such as software with dedicated hardware acceleration. Preferably the SLM comprises a reflective SLM (for compactness) but in general any type of pixellated microdisplay which is able to phase modulate light may be employed, optionally in association with an appropriate driver chip if needed.

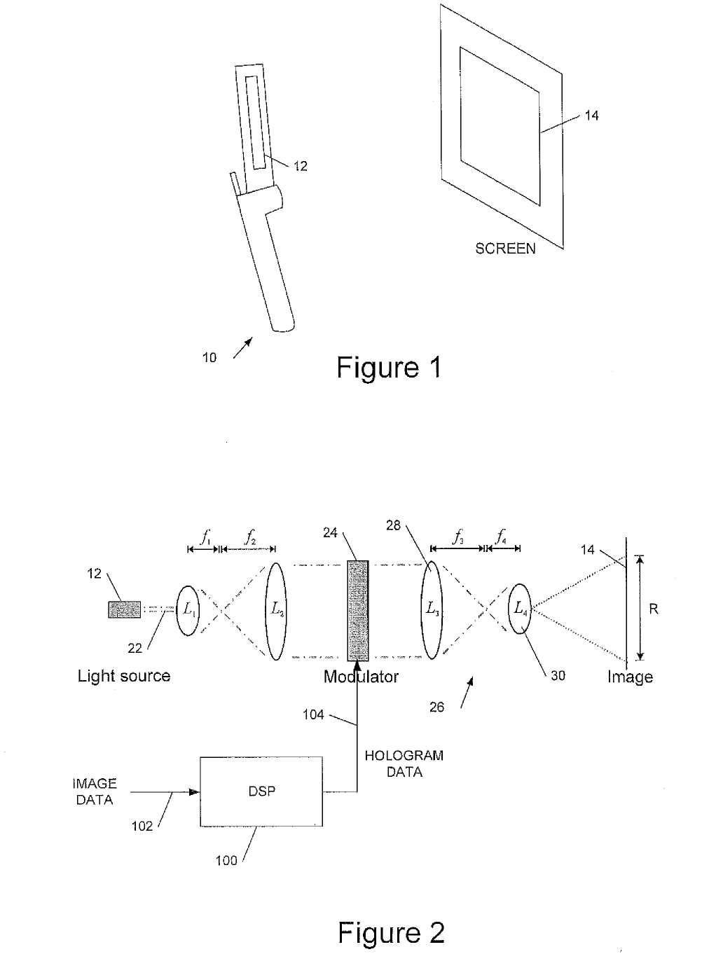

Referring now to FIG. 1, this shows an example a consumer electronic device 10 incorporating a hardware projection module 12 to project a displayed image 14. Displayed image 14 comprises a plurality of holographically generated sub-images each of the same spatial extent as displayed image 14, and displayed rapidly in succession so as to give the appearance of the displayed image. Each holographic sub-frame is generated along the lines described below. For further details reference may be made to GB 0329012.9 (ibid).

FIG. 2 shows an example optical system for the holographic projection module of FIG. 1. Referring to FIG. 2, a laser diode 20 (for example, at 532 nm), provides substantially collimated light 22 to a spatial light modulator 24 such as a pixellated liquid crystal modulator. The SLM 24 phase modulates light 22 with a hologram and the phase modulated light is provided a demagnifying optical system 26. In the illustrated embodiment, optical system 26 comprises a pair of lenses 28, 30 with respective focal lengths f₁, f₂, f₁<f₂, spaced apart at distance f₁+f₂. Optical system 26 increases the size of the projected holographic image by diverging the light forming the displayed image, as shown.

Still referring to FIG. 2, in more detail lenses L₁ and L₂ (with focal lengths f₁ and f₂ respectively) form the beam-expansion pair. This expands the beam from the light source so that it covers the whole surface of the modulator.

Lens pair L₃ and L₄ (with focal lengths f₃ and f₄ respectively) form a demagnification lens pair. This effectively reduces the pixel size of the modulator, thus increasing the diffraction angle. As a result, the image size increases. The increase in image size equal to the ratio of f₃ to f₄, which are the focal lengths of lenses L₃ and L₄ respectively.

Continuing to refer to FIG. 2, a digital signal processor 100 has an input 102 to receive image data from the consumer electronic device defining the image to be displayed. The DSP 100 implements a procedure (described below) to generate phase hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14 in the replay field (RPF).

The DSP 100 may comprise dedicated hardware and/or Flash or other read-only memory storing processor control code to implement a hologram generation procedure, in preferred embodiments in order to generate sub-frame phase hologram data for output to the SLM 24.

We now describe a preferred procedure for calculating hologram data for display on SLM 24. We refer to this procedure, in broad terms, as One Step Phase Retrieval (OSPR), although strictly speaking in some implementations it could be considered that more than one step is employed (as described for example in GB0518912.1 and GB0601481.5, incorporated by reference, where “noise” in one sub-frame is compensated in a subsequent sub-frame).

Thus we have previously described, in UK Patent Application No. GB0329012.9, filed 15 Dec. 2003, a method of displaying a holographically generated video image comprising plural video frames, the method comprising providing for each frame period a respective sequential plurality of holograms and displaying the holograms of the plural video frames for viewing the replay field thereof, whereby the noise variance of each frame is perceived as attenuated by averaging across the plurality of holograms.

Broadly speaking in our preferred method the SLM is modulated with holographic data approximating a hologram of the image to be displayed. However this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

A scheme such as this has the advantage of reduced computational requirements compared with schemes which attempt to accurately reproduce a displayed image using a single hologram, and also facilitate the use of a relatively inexpensive SLM.

Here it will be understood that the SLM will, in general, provide phase rather than amplitude modulation, for example a binary device providing relative phase shifts of zero and π(+1 and −1 for a normalised amplitude of unity). In preferred embodiments, however, more than two phase levels are employed, for example four phase modulation (zero, π/2, π, 3π/2), since with only binary modulation the hologram results in a pair of images one spatially inverted in respect to the other, losing half the available light, whereas with multi-level phase modulation where the number of phase levels is greater than two this second image can be removed. Further details can be found in our earlier application GB0329012.9 (ibid), hereby incorporated by reference in its entirety.

Although embodiments of the method are computationally less intensive than previous holographic display methods it is nonetheless generally desirable to provide a system with reduced cost and/or power consumption and/or increased performance. It is particularly desirable to provide improvements in systems for video use which generally have a requirement for processing data to display each of a succession of image frames within a limited frame period.

We have also described, in GB0511962.3, filed 14 Jun. 2005, a hardware accelerator for a holographic image display system, the image display system being configured to generate a displayed image using a plurality of holographically generated temporal sub-frames, said temporal sub-frames being displayed sequentially in time such that they are perceived as a single reduced-noise image, each said sub-frame being generated holographically by modulation of a spatial light modulator with holographic data such that replay of a hologram defined by said holographic data defines a said sub-frame, the hardware accelerator comprising: an input buffer to store image data defining said displayed image; an output buffer to store holographic data for a said sub-frame; at least one hardware data processing module coupled to said input data buffer and to said output data buffer to process said image data to generate said holographic data for a said sub-frame; and a controller coupled to said at least one hardware data processing module to control said at least one data processing module to provide holographic data for a plurality of said sub-frames corresponding to image data for a single said displayed image to said output data buffer.

In this preferably a plurality of the hardware data processing modules is included for processing data for a plurality of the sub-frames in parallel. In preferred embodiments the hardware data processing module comprises a phase modulator coupled to the input data buffer and having a phase modulation data input to modulate phases of pixels of the image in response to an input which preferably comprises at least partially random phase data. This data may be generated on the fly or provided from a non-volatile-data store. The phase modulator preferably includes at least one multiplier to multiply pixel data from the input data buffer by input phase modulation data. In a simple embodiment the multiplier simply changes a sign of the input data.

An output of the phase modulator is provided to a space-frequency transformation module such as a Fourier transform or inverse Fourier transform module. In the context of the holographic sub-frame generation procedure described later these two operations are substantially equivalent, effectively differing only by a scale factor. In other embodiments other space-frequency transformations may be employed (generally frequency referring to spatial frequency data derived from spatial position or pixel image data). In some preferred embodiments the space-frequency transformation module comprises a one-dimensional Fourier transformation module with feedback to perform a two-dimensional Fourier transform of the (spatial distribution of the) phase modulated image data to output holographic sub-frame data. This simplifies the hardware and enables processing of, for example, first rows then columns (or vice versa).

In preferred embodiments the hardware also includes a quantiser coupled to the output of the transformation module to quantise the holographic sub-frame data to provide holographic data for a sub-frame for the output buffer. The quantiser may quantise into two, four or more (phase) levels. In preferred embodiments the quantiser is configured to quantise real and imaginary components of the holographic sub-frame data to generate a pair of sub-frames for the output buffer. Thus in general the output of the space-frequency transformation module comprises a plurality of data points over the complex plane and this may be thresholded (quantised) at a point on the real axis (say zero) to split the complex plane into two halves and hence generate a first set of binary quantised data, and then quantised at a point on the imaginary axis, say 0j, to divide the complex plane into a further two regions (complex component greater than 0, complex component less than 0). Since the greater the number of sub-frames the less the overall noise this provides further benefits.

Preferably one or both of the input and output buffers comprise dual-ported memory. In some particularly preferred embodiments the holographic image display system comprises a video image display system and the displayed image comprises a video frame.

In an embodiment, the various stages of the hardware accelerator implement a variant of the algorithm given below, as described later. The algorithm is a method of generating, for each still or video frame I=I_{xy}, sets of N binary-phase holograms h⁽¹⁾ . . . h^{(N)}. Statistical analysis of the algorithm has shown that such sets of holograms form replay fields that exhibit mutually independent additive noise.

1. Let G_{xy}⁽ⁿ⁾=I_{xy} exp(jφ_{xy}⁽ⁿ⁾) where φ_{xy}⁽ⁿ⁾ is uniformly distributed between 0 and 2π for 1≦n≦N/2 and 1≦x,y≦m

2. Let gᵤᵥ⁽ⁿ⁾=F⁻¹[G_{xy}^{(u)}] where F⁻¹ represents the two-dimensional inverse Fourier transform open or, for 1≦n≦N/2

3. Let mᵤᵥ⁽ⁿ⁾= [symbol] {gᵤᵥ⁽ⁿ⁾} for 1≦n≦N/2

4. Let mᵤᵥ^{(n-1-N/2)}=ℑ{gᵤᵥ^{(n)} for} 1≦n≦N/2

5. Let

$${h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix}$$

where Q⁽ⁿ⁾=median(mᵤᵥ⁽ⁿ⁾) and 1≦n≦N

Step 1 forms N targets G_{xy}⁽ⁿ⁾ equal to the amplitude of the supplied intensity target I_{xy}, but with independent identically-distributed (i.i.d.), uniformly-random phase. Step 2 computes the N corresponding full complex Fourier transform holograms gᵤᵥ⁽ⁿ⁾. Steps 3 and 4 compute the real part and imaginary part of the holograms, respectively. Binarisation of each of the real and imaginary parts of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of muᵤᵥ⁽ⁿ⁾ is assumed to be zero. This assumption can be shown to be valid and the effects of making this assumption are minimal with regard to perceived image quality. Further details can be found in the applicant's earlier application (ibid), to which reference may be made.

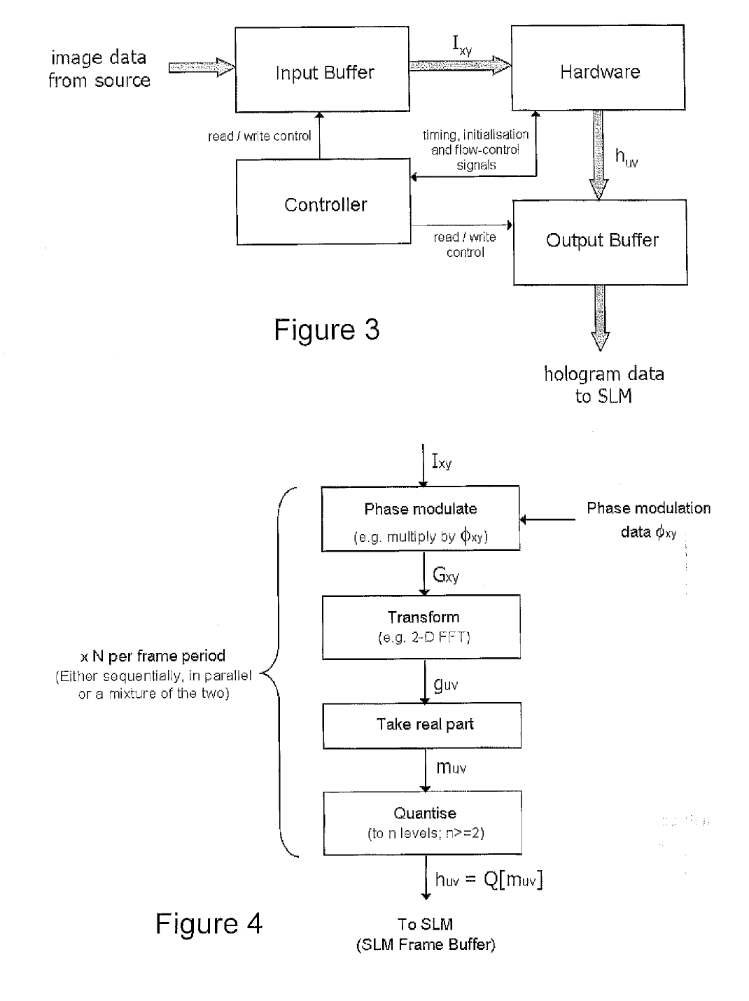

FIG. 3 shows a block diagram of an embodiment of a hardware accelerator for the holographic image display system of the module 12 of FIG. 1. The input to the system is preferably image data from a source such as a computer, although other sources are equally applicable. The input data is temporarily stored in one or more input buffer, with control signals for this process being supplied from one or more controller units within the system. Each input buffer preferably comprises dual-port memory such that data is written into the input buffer and read out from the input buffer simultaneously. The output from the input buffer shown in FIG. 1 is an image frame, labelled I, and this becomes the input to the hardware block. The hardware block, which is described in more detail using FIG. 2, performs a series of operations on each of the aforementioned image frames, I, and for each one produces one or more holographic sub-frames, h, which are sent to one or more output buffer. Each output buffer preferably comprises dual-port memory. Such sub-frames are outputted from the aforementioned output buffer and supplied to a display device, such as a SLM, optionally via a driver chip. The control signals by which this process is controlled are supplied from one or more controller unit. The control signals preferably ensure that one or more holographic sub-frames are produced and sent to the SLM per video frame period. In an embodiment, the control signals transmitted from the controller to both the input and output buffers are read/write select signals, whilst the signals between the controller and the hardware block comprise various timing, initialisation and flow-control information.

FIG. 4 shows an embodiment of a hardware block as described in FIG. 3, comprising a set of hardware elements designed to generate one or more holographic sub-frames for each image frame that is supplied to the block. In such an embodiment, preferably one image frame, I_{xy}, is supplied one or more times per video frame period as an input to the hardware block. The source of such image frames may be one or more input buffers as shown in FIG. 3. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block shown in the embodiment of FIG. 4 is to redistribute the energy of the input frame in the spatial-frequency domain, such that improvements in final image quality are obtained after performing later operations.

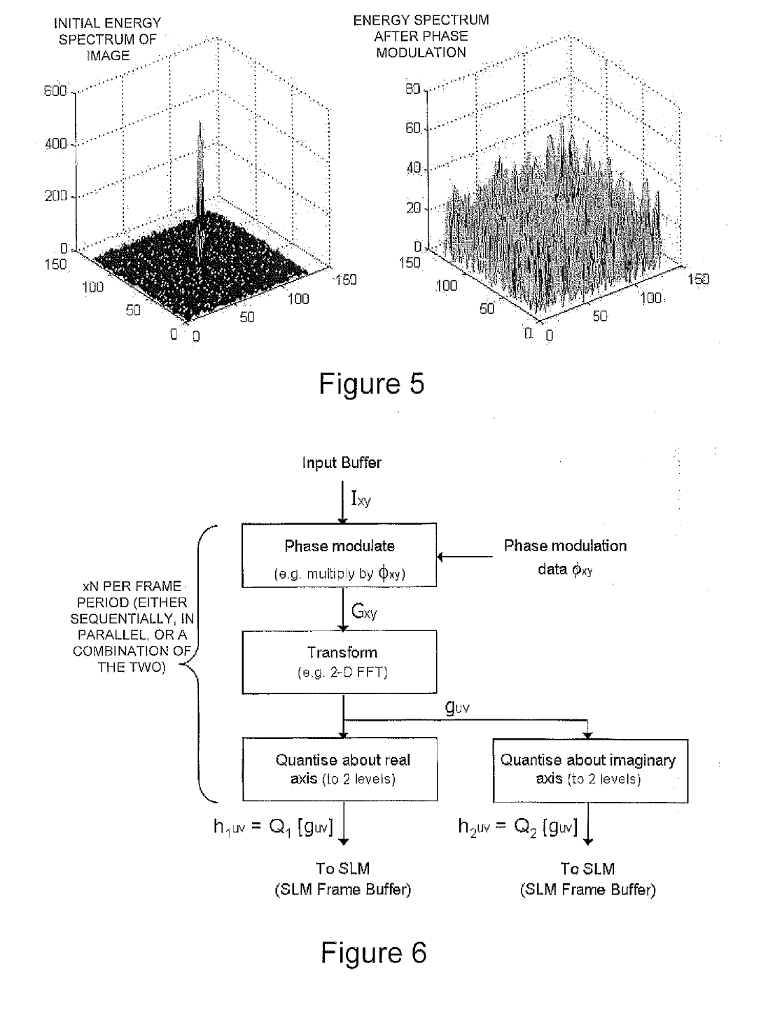

FIG. 5 shows an example of how the energy of a sample image is distributed before and after a phase-modulation stage in which a random phase distribution is used. It can be seen that modulating an image by such a phase distribution has the effect of redistributing the energy more evenly throughout the spatial-frequency domain.

The quantisation hardware that is shown in the embodiment of FIG. 4 has the purpose of taking complex hologram data, which is produced as the output of the preceding space-frequency transform block, and mapping it to a restricted set of values, which correspond to actual phase modulation levels that can be achieved on a target SLM. In an embodiment, the number of quantisation levels is set at two, with an example of such a scheme being a phase modulator producing phase retardations of 0 or π at each pixel. In other embodiments, the number of quantisation levels, corresponding to different phase retardations, may be two or greater. There is no restriction on how the different phase retardations levels are distributed—either a regular distribution, irregular distribution or a mixture of the two may be used. In preferred embodiments the quantiser is configured to quantise real and imaginary components of the holographic sub-frame data to generate a pair of sub-frames for the output buffer, each with two phase-retardation levels. It can be shown that for discretely pixellated fields, the real and imaginary components of the complex holographic sub-frame data are uncorrelated, which is why it is valid to treat the real and imaginary components independently and produce two uncorrelated holographic sub-frames.

FIG. 6 shows an embodiment of the hardware block described in FIG. 3 in which a pair of quantisation elements are arranged in parallel in the system so as to generate a pair of holographic sub-frames from the real and imaginary components of the complex holographic sub-frame data respectively.

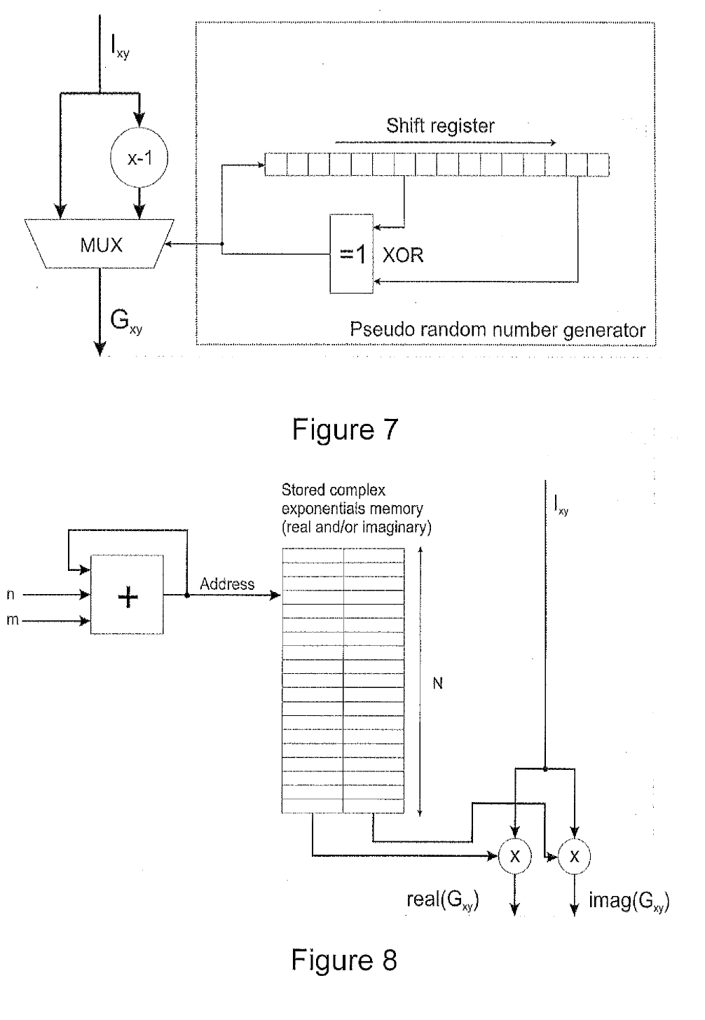

There are many different ways in which phase-modulation data, as shown in FIG. 4, may be produced. In an embodiment, pseudo-random binary-phase modulation data is generated by hardware comprising a shift register with feedback and an XOR logic gate. FIG. 7 shows such an embodiment, which also includes hardware to multiply incoming image data by the binary phase data. This hardware comprises means to produce two copies of the incoming data, one of which is multiplied by −1, followed by a multiplexer to select one of the two data copies. The control signal to the multiplexer in this embodiment is the pseudo-random binary-phase modulation data that is produced by the shift-register and associated circuitry, as described previously.

In another embodiment, pre-calculated phase modulation data is stored in a look-up table and a sequence of address values for the look-up table is produced, such that the phase-data read out from the look-up table is random. In this embodiment, it can be shown that a sufficient condition to ensure randomness is that the number of entries in the look-up table, N, is greater than the value, m, by which the address value increases each time, that m is not an integer factor of N, and that the address values ‘wrap around’ to the start of their range when N is exceeded. In a preferred embodiment, N is a power of 2, e.g. 256, such that address wrap around is obtained without any additional circuitry, and m is an odd number such that it is not a factor of N.

FIG. 8 shows suitable hardware for such an embodiment, comprising a three-input adder with feedback, which produces a sequence of address values for a look-up table containing a set of N data words, each comprising a real and imaginary component. Input image data, I_{xy}, is replicated to form two identical signals, which are multiplied by the real and imaginary components of the selected value from the look-up table. This operation thereby produces the real and imaginary components of the phase-modulated input image data, G_{xy}, respectively. In an embodiment, the third input to the adder, denoted n, is a value representing the current holographic sub-frame. In another embodiment, the third input, n, is omitted. In a further embodiment, m and N are both be chosen to be distinct members of the set of prime numbers, which is a strong condition guaranteeing that the sequence of address values is truly random.

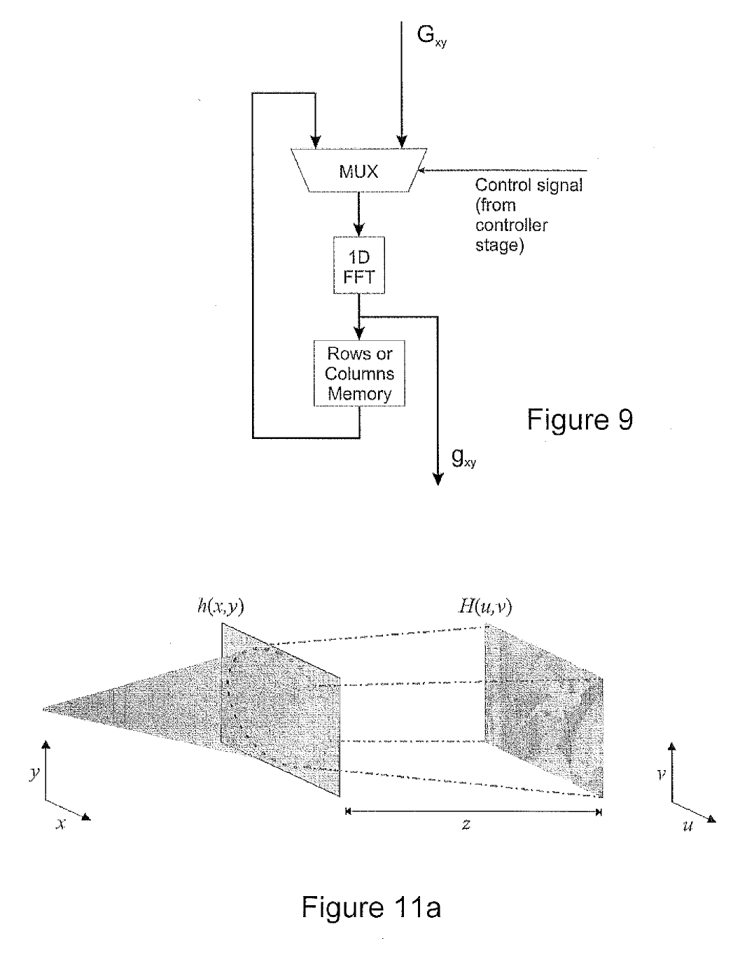

FIG. 9 shows an embodiment of hardware which performs a 2-D FFT on incoming phase-modulated image data, G_{xy}, as shown in FIG. 4. In this embodiment, the hardware to perform the 2-D FFT operation comprises a 1-D FFT block, a memory element for storing intermediate row or column results, and a feedback path from the output of the memory to one input of a multiplexer. The other input of this multiplexer is the phase-modulated input image data, G_{xy}, and the control signal to the multiplexer is supplied from a controller block as shown in FIG. 4. Such an embodiment represents an area-efficient method of performing a 2-D FFT operation.

In other implementations the operations illustrated in FIGS. 4 and/or 6 may be implemented partially or wholly in software, for example on a general purpose digital signal processor.

### Lens Encoding

Reference may be made to the applicant's co-pending international patent application number PCT/GB2007/050157 filed 27 Mar. 2007, hereby incorporated by reference in its entirety.

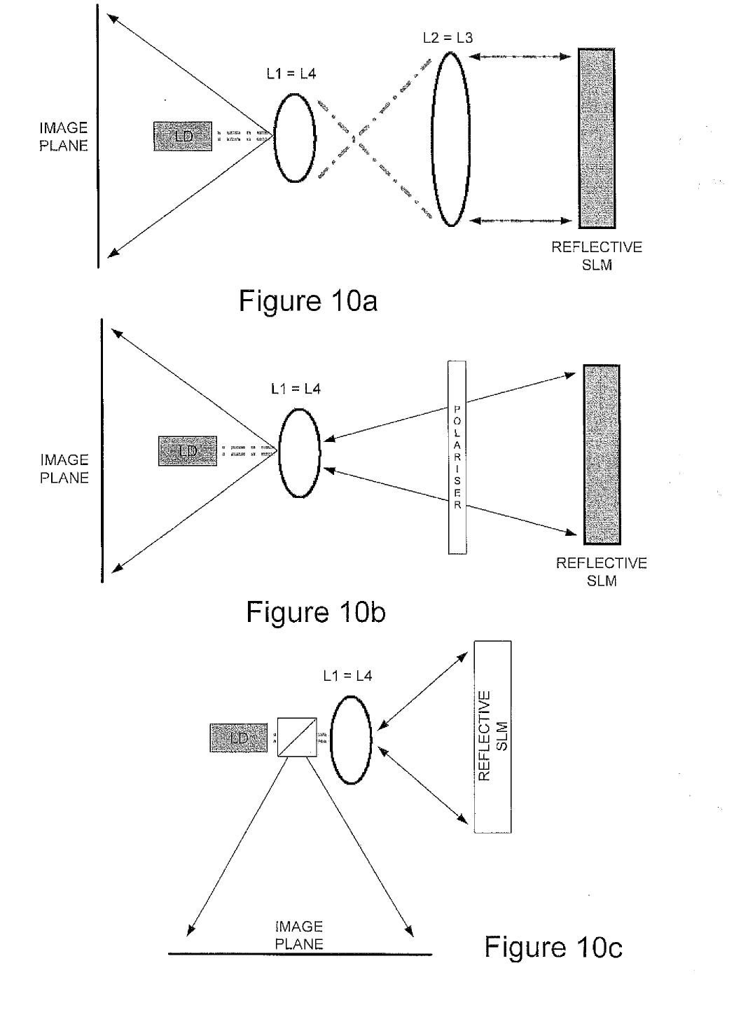

FIG. 10a shows a conceptual diagram of an embodiment of a holographic display device using a reflective spatial light modulator, illustrating sharing of the lenses for the beam expander and demagnification optics. In particular lenses L₂ and L₃ of FIG. 2 are shared, implemented as a single, common lens which, in embodiments is encoded into the hologram displayed on the reflective SLM. Thus one embodiment of a practical, physical system is shown in FIG. 10b, in which a polariser is included to suppress interference between light travelling in different directions, that is into and out of the SLM. In the arrangement of FIG. 10b the laser diode results in a dark patch in the centre of the image plane and therefore one alternative is to use the arrangement of FIG. 10c. In the arrangement of FIG. 10c a polarising beam splitter is used to direct the output, modulated light at 90 degrees on the image plane, and also to provide the function of the polariser in FIG. 10b.

We now describe encoding lens power into the hologram by means of Fresnel diffraction.

We have previously described systems using far-field (or Fraunhofer) diffraction, in which the replay field F_{xy} and hologram hᵥ are related by the Fourier transform:

F_{xy}=F[hᵤᵥ] (1)

In the near-field (or Fresnel) propagation regime, RPF and hologram are related by the Fresnel transform which, using the same notation, can be written as:

F_{xy}=FR[hᵤᵥ] (2)

The discrete Fresnel transform, from which suitable binary-phase holograms can be generated, is now introduced and briefly discussed.

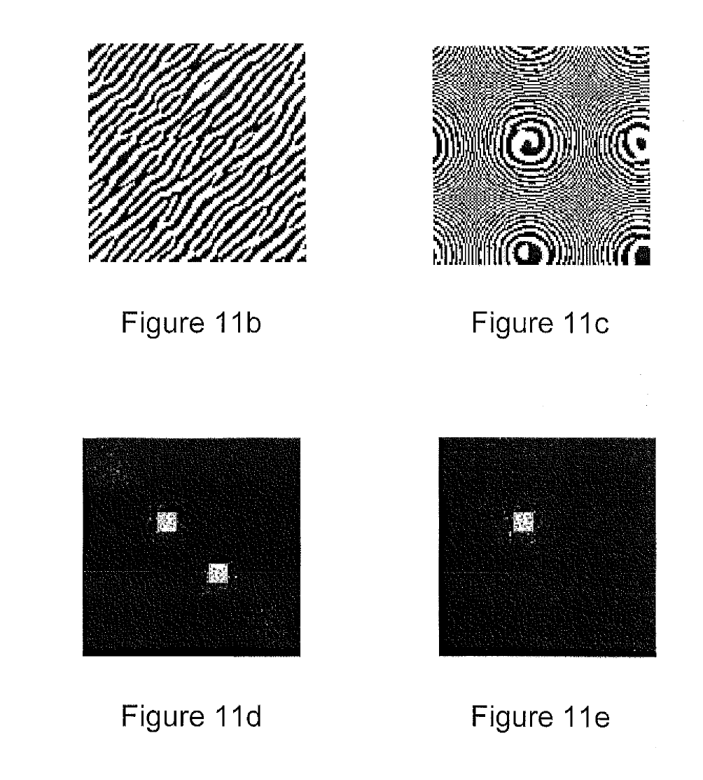

The Fresnel transform describes the diffracted near field F(x,y) at a distance z, which is produced when coherent light of wavelength λ interferes with an object h(u,v). This relationship, and the coordinate system, is shown in FIG. 11a. In continuous coordinates, the transform is defined as:

$$F ( x ) = \frac{{e}^{\frac{j 2 π z}{λ}}}{j λ z} \int h ( u ) exp ( - \frac{j π}{λ z} {‖ x - u ‖}^{2} \} d u \qquad ( 3 )$$

where x=(x,y) and u=(u,v), or

$$F ( x , y ) = \frac{{e}^{\frac{j 2 π z}{λ}}}{j λ z} {e}_{- ∞}^{\frac{j π}{λ z} {( {x}^{2} + {y}^{2} )}_{∞}} h ( u , v ) {e}^{\frac{j π}{λ z} ( {u}^{2} + {v}^{2} )} exp \{ - \frac{2 j π}{λ z} ( ux + vy ) \} d u d v . \qquad ( 4 )$$

This formulation is not suitable for a pixellated, finite-sized hologram h_{xy}, and is therefore discretised. This discrete Fresnel transform can be expressed in terms of a Fourier transform

H_{xy}=F_{xy}⁽¹⁾·F[Fᵤᵥ⁽²⁾hᵤᵥ] (5)

where

$$\begin{matrix}{F}_{xy}^{( 1 )} = \frac{{Δ}_{x} {Δ}_{y}}{j λ z} exp \frac{j 2 π z}{λ} exp \frac{j π}{λ z} [ {( \frac{x}{N {Δ}_{x}} )}^{2} + {( \frac{y}{M {Δ}_{y}} )}^{2} ] \\ and & ( 6 ) \\ {F}_{uv}^{( 2 )} = exp \frac{j π}{λ z} ( {u}^{2} {Δ}_{x} + {v}^{2} {Δ}_{y} ) . & ( 7 )\end{matrix}$$

In effect the factors F⁽¹⁾ and F⁽²⁾ in equation (5) turn the Fourier transform in a Fresnel transform of the hologram h. The size of each hologram pixel is Δₓ×Δ_{y}, and the total size of the hologram is (in pixels) N×M. In equation (7), z defines the focal length of the holographic lens. Finally, the sample spacing in the replay field is:

$${Δ}_{u} = \frac{λ z}{N {Δ}_{x}} \\ {Δ}_{v} = \frac{λ z}{N {Δ}_{y}} \qquad ( 8 )$$

so that the dimensions of the replay field are

$$\frac{λ z}{{Δ}_{x}} \times \frac{λ z}{{Δ}_{y}} ,$$

consistent with the size of replay field in the Fraunhofer diffraction regime.

The OSPR algorithm can be generalised to the case of calculating Fresnel holograms by replacing the Fourier transform step by the discrete Fresnel transform of equation 5. Comparison of equations 1 and 5 show that the near-field propagation regime results in very different replay field characteristics, resulting in two potentially useful effects. These are demonstrated in FIGS. 11b-11e, which show Fresnel and Fourier binary holograms calculated using OSPR, and their respective simulated replay fields.

The significant advantage associated with binary Fresnel holograms is that the diffracted near-field does not contain a conjugate image. In the Fraunhofer diffraction regime the replay field is the Fourier transform of the real term hᵤᵥ, giving rise to conjugate symmetry. In the case of Fresnel diffraction, however, equation 5 shows that the replay field is the Fourier transform of the complex term Fᵤᵥ⁽²⁾hᵤᵥ. The differences in the resultant RPFs are clearly demonstrated in FIGS. 11d and 11e.

It is also evident from equation 4 that the diffracted field resulting from a Fresnel hologram is characterised by a propagation distance z, so that the replay field is formed in one plane only, as opposed to everywhere where z is greater than the Goodman distance [J. W. Goodman, Introduction to Fourier Optics, 2nd ed. New York: McGraw-Hill, 1996, ch. The Fraunhofer approximation, pp. 73-75] in the case of Fraunhofer diffraction. This indicates that a Fresnel hologram incorporates lens power, which is reflected in the circular structure of the Fresnel hologram shown in FIG. 11c. This is particularly useful effect to exploit in a holographic projection system, since incorporation of lens power into the hologram means that system cost, size and weight can be reduced. Furthermore, the focal plane in which the image is formed can also be altered simply by recalculating the hologram rather than changing the entire optical design.

We describe below designs for holographic projection systems which exploit these advantageous features of Fresnel holograms. There is an increase SNR penalty but error diffusion may be employed as a method to mitigate this.

We next describe variable demagnification.

Referring back again to FIG. 2, this shows a simple optical architecture for a holographic projector. The lens pair L₁ and L₂ form a Keplerian telescope or beam expander, which expands the laser beam to capture the entire hologram surface, so that severe low-pass filtering of the replay field does not result. The reverse arrangement is used for the lens pair L₃ and L₄, effectively demagnifying the hologram and consequently increasing the diffraction angle. The resultant increase in the replay field size R is termed the “demagnification” of the system, and is set by the ratio of focal lengths f₄ to f₃.

We have previously demonstrated the operation of a projection system using a reconfigurable Fourier hologram as the diffracting element. However, the preceding discussion indicates that it is possible to remove the lens L₃ from the optical system by employing a Fresnel hologram which encodes the equivalent lens power. The output image from the projector would still be in-focus at all distances from the output lens L₄, but due to the characteristics of near-field propagation, is free from the conjugate image artifact. L₃ is the larger of the lens pair, as it has the longer focal length, and removing it from the optical path significantly reduces the size and weight of the system.

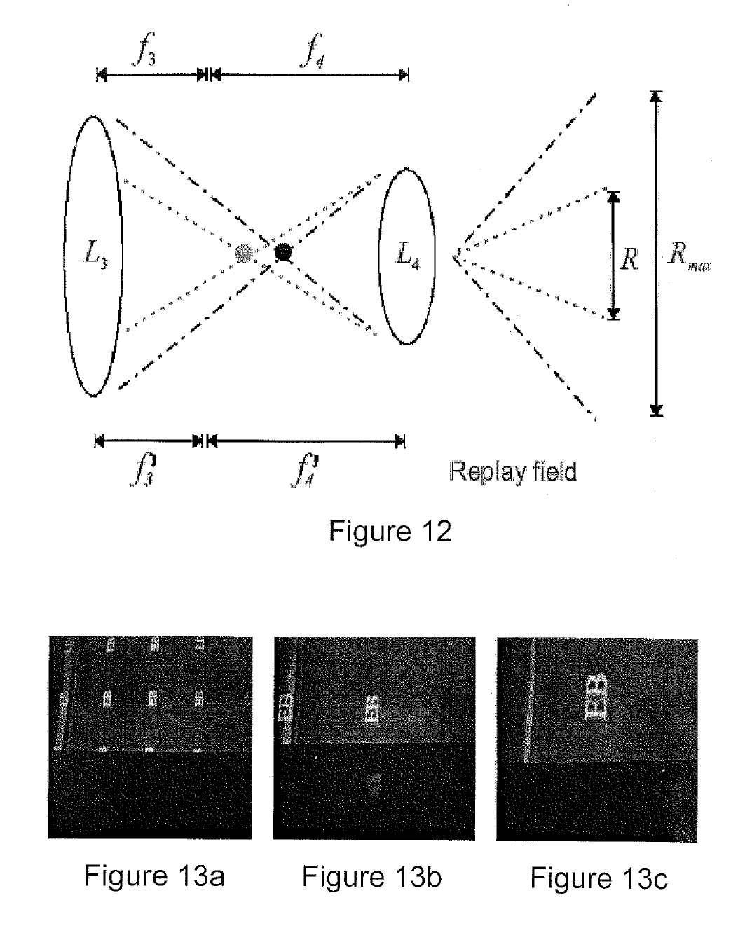

The use of a reconfigurable Fresnel hologram forms the basis for a novel variable demagnification effect. The demagnification D, and hence the size of the replay field at a particular z, is dependent upon the ratio of focal lengths of L₃ and L₄. If a dynamically addressable SLM device is used to display a Fresnel hologram encoding L₃, it is therefore possible to vary the size of the RPF simply by altering the lens power of the hologram. If the focal length of the holographic lens L₃ is altered to vary the demagnification, then either the focal length or the position of L₄ should also be changed as shown in FIG. 12. When the focal points of L₃ and L₄ coincide in a first configuration, the demagnification is at a maximum value

$${D}_{max} = \frac{{f}_{3}}{{f}_{4}} ,$$

thus giving rise to a replay field of size Rₘₐₓ. In a second configuration, however, the focal lengths f₃ and f₄ have changed to f₃ and f₄ respectively. Since f₃<f₄, the demagnification D is now smaller than Dₘₐₓ. This is compensated by an increase in f₄ so that the focal points of each lens coincide.

An experimental verification of the variable demagnification principle was performed using a 100 mm focal length lens in place of L₄. Three Fresnel holograms were calculated using OSPR with N=24 subframes, each of each were designed to form an image in the planes z=100 mm, z=200 mm and z=400 mm. A CRL Opto Limited (Forth Dimension Displays Limited, of Scotland, UK) SXGA SLM device with pixel pitch Δₓ=Δ_{y}=13.62 μm was used to display the holograms, and the resulting replay fields—projected onto a non-diffusing screen—were captured with a digital camera. The results are shown in FIG. 13, and clearly show the replay field scaling caused by the variable demagnification introduced by each of the Fresnel holograms.

Preferably, to avoid having to move the lens L₄ a variable focal-length lens is employed. Two examples of such a lens are manufactured by Varioptic [“PAMS-1000 tunable lens unit,” www.varioptic.com/en/PAMS-1000.php, Tech. Rep., 2005. [Online]. Available: www.varioptic.com/en/PAMS-1000.php] and Philips [P. Hendriks and S. Kuiper, “Through a lens sharply,” in IEEE Spectrum, vol. 5, no. 12, 2004]. Both utilise the electrowetting phenomenon, in which a water drop is deposited on a metal substrate covered in a thin insulating layer. A voltage applied to the substrate modifies the contact angle of the liquid drop, thus changing the focal length. Other, less suitable, liquid lenses have also been proposed in which the focal length is controlled by the effect of a lever assembly on the lens aperture size [H. Ren, Y. Fana, S. Gauza, and S. Wu, “Tunable-focus cylindrical liquid-crystal lens,” Jap. J. Appl. Phys., vol. 43, pp. 652-653, 2004]. Solid-state variable focal length lenses, using the birefringence change of liquid crystal material under an applied electric field, have also been reported [M. Ye, B. Wang, and S. Sato, “Liquid-crystal lens with a focal length that is variable in a wide range,” Applied Optics, vol. 43, pp. 6407-6412, 2004, B. Wang, M. Ye, and S. Sato, “Liquid crystal lens with stacked structure of liquid-crystal layers,” Optics Communications, vol. 250, pp. 266-273, 2005 and H. Ren, “Variable-focus liquid lens by changing aperture,” Appl. Phys. Lett., vol. 86, pp. 2 111 071-2 111 073, 2005].

The focal length of the tunable lens is adjusted in response to changes in f₃. An expression for the demagnification for a system employing a tunable lens in place of L₄ can be obtained by considering the geometry of FIG. 12, in which the total optical path length is preserved between the two configurations, so that:

f₄+f₃=f₄+f₃ (9)

Using the definitions of D and Dₘₐₓ, then equation 9 this can be rearranged to give

$$\frac{D + 1}{{D}_{max} + 1} = \frac{{f}_{4}}{{f}_{4}} \qquad ( 10 )$$

If the Varioptic AMS-1000 tunable focal length lens (which has a tuning range of 20-25 diopters) is employed, then for f₃=100 mm the demagnification D is continuously variable from 1.8 to 2.5. Care should be taken to ensure that lens L₄ captures as much of the diffracted field as possible. From equation 8, the Fresnel field is approximately 4 mm square at z=100 mm, which is larger than the effective aperture of the Varioptic device. As a result, some low-pass filtering of the replay field is likely to result if this particular device is employed.

We now describe lens sharing.

It was shown above that one half of the demagnification lens pair could be encoded onto the hologram, thereby reducing the lens count of the projector design by one. It was especially useful that the encoded lens was the larger of the pair, thus giving rise to a compact optical system.

The same technique can also be applied to the beam-expansion lens pair L₁ and L₂, which perform the reverse function to the pair L₃ and L₄. It is therefore possible to share a lens between the beam-expansion and demagnification assemblies, which can be represented as lens function encoded onto a Fresnel hologram. This results in a holographic projector which requires only two small, short focal length lenses. The remaining lenses are encoded onto a hologram, which is used in a reflective configuration.

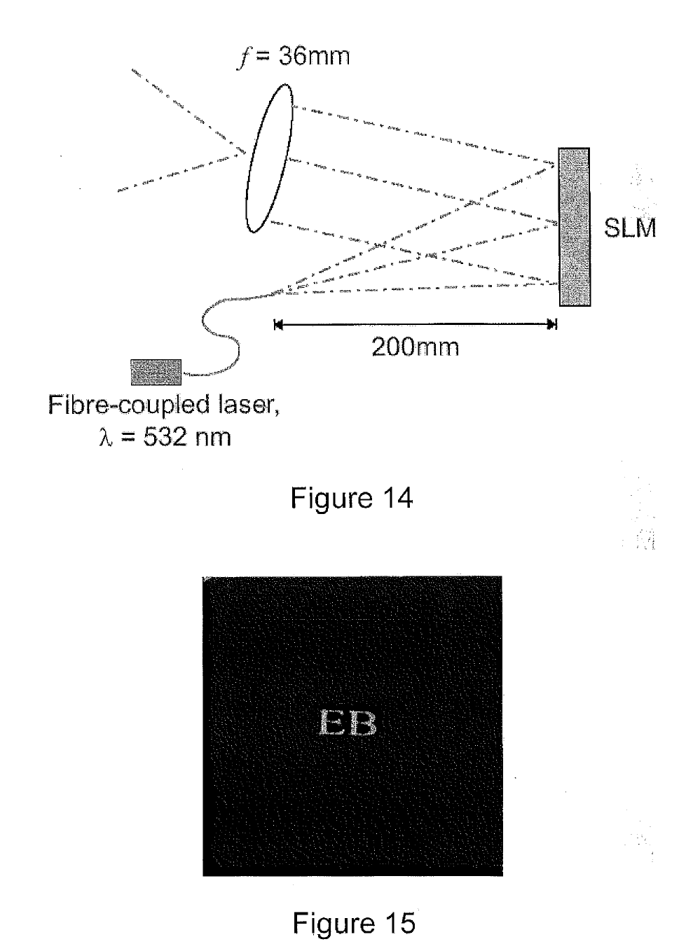

An experimental projector was constructed to demonstrate the lens-sharing technique, and the optical configuration is shown in FIG. 14. A fibre-coupled laser was used to illuminate a CRL Opto reflective SLM, which displayed N=24 sets of Fresnel holograms each with z=100 mm. Since the light from the fiber end was highly divergent, this removed the need for lens L₁. The output lens L₄ had a focal length of f=36 mm, giving a demagnification D of approximately three. Polarisers were used to remove the large zero order associated with Fresnel diffraction, but have been omitted from FIG. 14 for clarity. The angle of reflection was also kept small to avoid defocus aberrations.

An example image, projected on a screen and captured in low-light conditions with a digital camera, is shown in FIG. 15. The replay field has been optically enlarged by factor of approximately three by the demagnification of the hologram pixels and, as the architecture is functionally equivalent to the simple holographic projector of FIG. 2; the image is in focus at all points and without conjugate image.

We next briefly discuss the SNR (signal-to-noise ratio) of images formed by Fresnel holograms.

Fresnel holograms have properties which are particularly advantageous for the design of a holographic projector. However, there is an associated cost associated with encoding a lens function onto a hologram, which manifests itself as a degradation of RPF SNR: Taking the real (or imaginary) part of a complex Fourier hologram does not introduce quantisation noise into the replay field—instead, a conjugate image results. This is not true in the Fresnel regime, however, because the Fresnel transform is not conjugate symmetric. The effect of taking the real part of a complex Fresnel hologram is to distribute noise, having the same energy as the desired signal, over the entire replay field. However it is possible to improve this by using error diffusion; two example algorithms for the design of Fresnel holograms using a modified error diffusion algorithm are presented by Fetthauer [F. Fetthauer, S. Weissbach, and O. Bryngdahl, “Computer-generated fresnel holograms: quantization with the error diffusion algorithm,” Optics Communications, vol. 114, 1995] and Slack [J. Slack, P. Dainty, P. J. M. Parmiter, T. J. Hall, and H. Imam, “Fresnel elements designed by generalised error diffusion,” in Workshop on Diffractive Optics, Prague, 1995]. This shows that a carefully chosen diffusion kernel can significantly increase the image SNR, thereby offsetting the degradation due to the use of a Fresnel hologram.

The use of near-field holography also results in a zero-order which is approximately the same size as the hologram itself, spread over the entire replay field rather than located at zero spatial frequency as for the Fourier case. However this large zero order can be suppressed either with a combination of a polariser and analyzer or by processing the hologram pattern [C. Liu, Y. Li, X. Cheng, Z. Liu, et al., “Elimination of zero-order diffraction in digital holography,” Optical Engineering, vol. 41, 2002].

We next describe an implementation of a hologram processor, in this example using a modification of the above-described OSPR procedure, to calculate a Fresnel hologram using equation (5).

Referring back to steps 1 to 5 of the above-described OSPR procedure, step 2 was previously a two-dimensional inverse Fourier transform. To implement a Fresnel hologram, also encoding a lens, as described above an inverse Fresnel transform is employed in place of the previously described inverse Fourier transform. The inverse Fresnel transform may take the following form (based upon equation (5) above):

$$\frac{{F}^{- 1} [ \frac{{H}_{xy}}{{F}_{xy}^{( 1 )}} ]}{{F}_{uv}^{( 2 )}}$$

Similarly the transform shown in FIG. 4 is a two-dimensional inverse Fresnel transform (rather than a two-dimensional FFT) and, likewise the transform in FIG. 6 is a Fresnel (rather than a Fourier) transform. In the hardware of FIG. 9 the one-dimensional FFT block is replaced by an FRT (Fresnel transform) block so that the hardware of FIG. 9 performs a two-dimensional FRT rather than a two-dimensional FFT. Further because of the scale factors F_{xy} and Fᵤᵥ mentioned above, one scale factor is preferably incorporated within the loop shown in FIG. 9 and a second multiplies the result.

### Aberration Correction

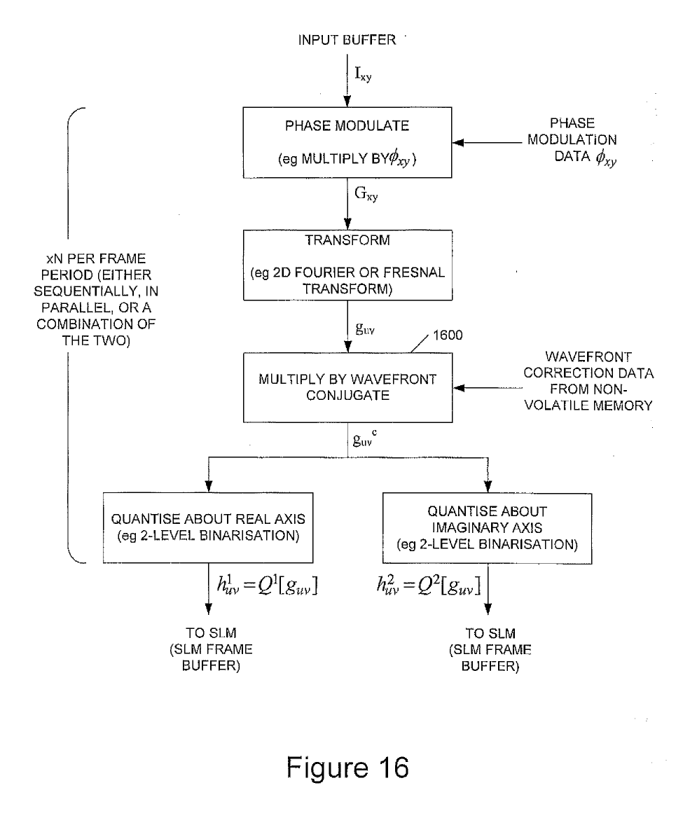

Referring now to FIG. 16, this shows a flow diagram of a procedure which broadly corresponds to that of FIG. 6 (and which may be implemented in hardware, software or a combination of the two) including an additional step 1600 to perform aberration correction for a head up display displaying an image on a curved display surface. As can be seen from FIG. 16, the additional step is to multiply the hologram data by a conjugate of the distorted wavefront, which may be determined from a ray tracing simulation software package such as ZEMAX. In some preferred embodiments the (conjugate) wavefront correction data is stored in non-volatile memory. For any particular vehicle, the shape of the curved display screen may be used to determine wavefront correction data and thus by employing this data in a holographic image projection system broadly of the type previously described a head up display may be tailored or configured for a particular vehicle. It will be appreciated that, in embodiments, the only change between implementation of the same head up display hardware in different vehicles is a change in the wavefront correction data stored in the non-volatile memory. Any type of non-volatile memory may be employed including, but not limited to, Flash memory and various types of electrically or mask programmed ROM (Read Only Memory).

In some embodiments the wavefront correction may be represented in terms of Zernike modes. Thus a wavefront W=exp (iΨ) may be expressed as an expansion in terms of Zernike polynomials as follows:

$$W = exp ( i Ψ ) = exp ( i {\sum }_{j} {a}_{j} {Z}_{j} ) \qquad ( 11 )$$

Where Zⱼ is a Zernike polynomial and aⱼ is a coefficient of Zⱼ. Similarly a phase conjugation of the Ψ_{c} of the wavefront Ψ may be represented as:

$${Ψ}_{c} = {\sum }_{j} {c}_{j} {Z}_{j} \qquad ( 12 )$$

For correcting the wavefront preferably Ψ_{c}≅Ψ. Thus using the notation previously used with reference to FIG. 6, for (uncorrected) hologram data gᵤᵥ (although hᵤᵥ is also used above with reference to lens encoding), the corrected hologram data gᵤᵥ^{c} can be expressed as follows:

gᵤᵥ^{c}=exp(iΨ_{c})gᵤᵥ (13)

The operation of Equation (3) is performed in step 1600 of FIG. 16 (or by hardware configured to implement such an operation).

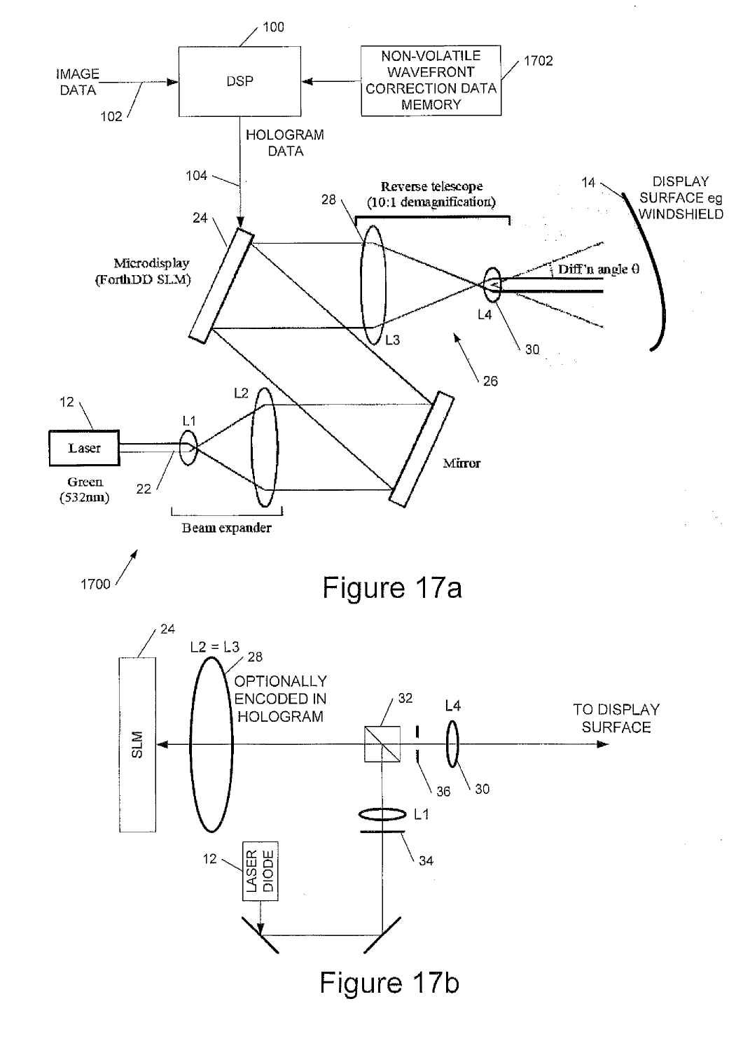

Referring now to FIG. 17a, this shows an embodiment of a head up display 1700 in which like elements to those of FIG. 2 are indicated by like reference numerals. It can be seen, however, that the display surface 14, for example the windshield, is curved, and that non-volatile memory 1702 is provided to store wavefront correction data, and is coupled to signal processor 100, the signal processor being different to that shown in FIG. 2, and in particular, in embodiments being configured to implement the procedure of FIG. 16. Embodiments of memory 1702 may comprise Flash RAM or ROM as previously described.

FIG. 17b shows an alternative optical configuration using a reflective SLM in which the functions of lenses L2 and L3 are shared in a single lens 28 which may, in embodiments, be encoded in the hologram displayed on the SLM 24, as previously described. In a similar way one or more lenses of a replay optical system to provide an enlarged image on a display screen such as a windshield.

We now describe some techniques which may be employed to determine the wavefront, and hence a phase conjugation of the wavefront for modifying the displayed hologram data for correcting the displayed image. Further details can be found in “Aberration correction in an adaptive free-space optical interconnect with an error diffusion algorithm”, D. Gil-Leyva, B. Robertson, T. D. Wilkinson, C. J. Henderson, Applied Optics, Vol. 45, No. 16, p. 3782-3792, 1 Jun. 2006.

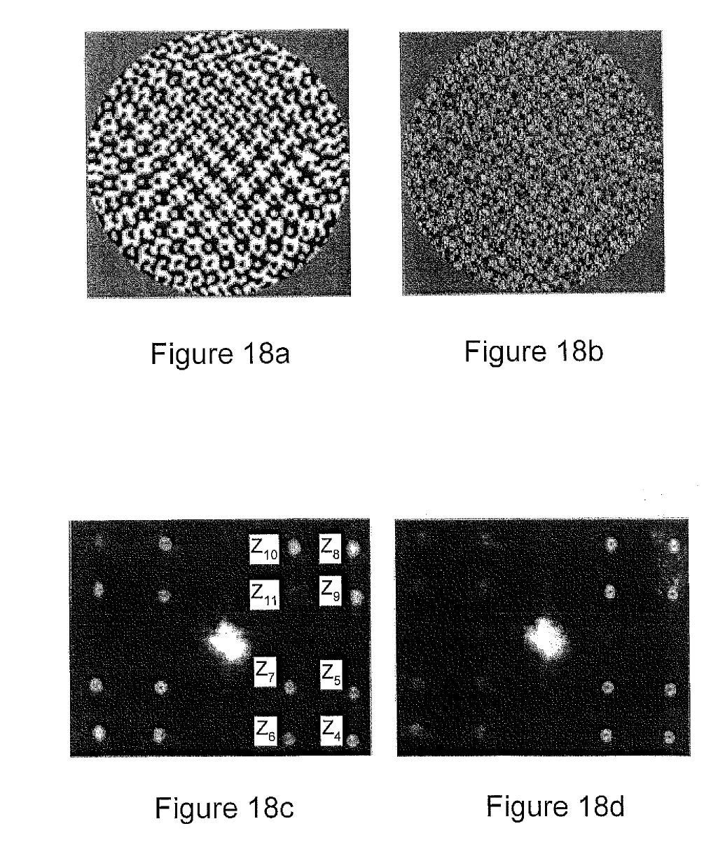

Broadly speaking a binary phase pattern representing one or more Zernike modes is displayed as a diffraction pattern on an SLM and then the +1 and −1 orders provide positive and negative bias aberration terms so that the aberration can be straightforwardly determined by taking the difference between the normal and conjugate portions of the image in the replay field. The displayed phase pattern may comprise a linear scaling of a Zernike mode or multiple Zernike modes may be multiplexed into a single diffractive element using a computer generated hologram procedure, preferably an error diffusion algorithm. Details are given in the Gil-Leyva et al. paper (ibid) and FIGS. 18a and 18b, which are taken from the paper, show illustrative example diffraction patterns.

FIG. 18c shows an example replay field; the conjugate position of each spot in the right hand half of the replay field is found by rotating the replay field by 180° about the central, zeroth order. It can be seen this example that Z₁₁ is substantially absent, but present in the conjugate image, indicating substantial spherical aberration. FIG. 18d shows the replay field of a conjugate wavefront in the diffraction plane which, as expected, shows bright spots in the +1 order and reduced brightness spots in the −1 order, the combination of this with the distorted wavefront correcting the wavefront. Optionally an iterative technique can be used, correcting again after compensation of the wavefront, for increased accuracy.

In more detail, the above outlined technique uses wavefront biasing in which a known phase Φ is added to an incoming wavefront for a first intensity measurement and then subtracted from the wavefront for a second intensity measurement. If Φ=bⱼZⱼ where bⱼ is the coefficient of the jth Zernike mode and if the mode is displayed as a binarised diffraction pattern, for example on a binary phase SLM, then the +1 and −1 orders provide the positive and negative bias aberration terms and the intensity difference ΔI=I₊₁−I₋₁ is given by ΔI=Sₖ×aₖ where Sₖ is the sensitivity of the sensor to Zernike mode k and aₖ represents the magnitude of the aberration of the type specified by Zernike mode k. Preferably two diffraction patterns are created, one from one or more Zernike modes as described above, and another computer generated to provide the same replay field (pattern of spots) but without aberration biasing (that is computer generated in a conventional manner rather than from a combination of one or more Zernike modes). If B₊ and B₋ defines the mean gray value in small circle around the spot for the +1 and −1 modes respectively before aberration biasing and A₊ and A₋ corresponding information after aberration biasing then the differential intensity w provides a better estimate of the contribution to aberration of a particular Zernike mode, where w is given by:

$$w = \frac{( {A}_{+} - {B}_{+} ) - ( {A}_{-} - {B}_{-} )}{{B}_{+} + {B}_{-}} \qquad ( 4 )$$

As previously mentioned, optionally an iterative procedure can be employed in which wⱼ is multiplied by a gain parameter to determine the contribution of a Zernike mode to the wavefront correction, the gain parameter being experimentally variable to determine the rapidity of convergence on a wavefront correction.

The above-described wavefront correction technique is merely one way in which a wavefront may be obtained for use in the above-described holographic image projection system for compensating for aberrations caused by display on a curved display surface. The skilled person will understand that many other techniques are possible including, but not limited to, direct or indirect measurement of the uncorrected wavefront in the optical system, for example using a Shack-Hartman sensor prior to applying the wavefront correction, and/or ray tracing/simulation techniques to calculate the uncorrected wavefront for applying as a correction.

Although embodiments of the techniques we have described above are particularly advantageous for head up displays where often an image is projected onto a curved display surface, the skilled person will understand that the techniques we have described are not limited to such applications and may, in general, be employed in other applications in which a projection onto a display surface which is not flat but which can be characterised, is desired.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A holographic head up display (HUD) for a vehicle to display an image holographically on a display surface of the vehicle, the HUD comprising:
a spatial light modulator (SLM) to display a hologram;
an illumination system to illuminate said displayed hologram;
projection optics to project light from said illuminated displayed hologram onto said display surface to form said image; and
a processor having an input to receive image data for display and having an output for driving said SLM, and wherein said processor is configured to process said image data to generate hologram data for display on said SLM to form said image on said display surface;
said HUD further comprising a non-volatile data memory coupled to said processor to store wavefront correction data for said display surface; and
wherein said processor is configured to apply a wavefront correction responsive to said stored wavefront correction data when generating said hologram data to correct said image for aberration due to a shape of said display surface.

2. A holographic head up display (HUD) as claimed in claim 1 wherein said wavefront correction data comprises phase data, and wherein said processor is configured to phase modulate said hologram data with said phase data.

3. A holographic head up display (HUD) as claimed in claim 1 wherein said processor is configured to quantise said hologram data for driving said SLM.

4. A holographic head up display (HUD) as claimed in claim 1, wherein said processor is configured to generate a plurality of temporal holographic subframes for display in rapid succession on said SLM such that corresponding temporal subframe images on said display surface average in an observer's eye to give the impression of said displayed image.

5. A holographic head up display (HUD) as claimed in claim 1 wherein at least a portion of said projection optics is encoded in said displayed hologram, and wherein said hologram data includes data for said encoded portion of said projection optics.

6. A holographic head up display (HUD) as claimed in claim 1 wherein said wavefront correction data comprises data defining a phase map of a portion of said display surface on which said image is to be displayed.

7. A holographic head up display (HUD) as claimed in claim 1 incorporated into a vehicle, wherein said display surface comprises a windshield.

8. A method of displaying an image holographically on a display surface, the method comprising:
inputting image data defining said image for display;
generating hologram data from said image data;
using said hologram data to display said image; and
wherein said generating of said hologram data further comprises correcting for an optical aberration due to a shape of said display surface.

9. A method as claimed in claim 8 wherein said correcting comprises multiplying by a conjugate of a phase map of said display surface.

10. A method as claimed in claim 8 wherein said displaying comprises projecting a hologram generated using said hologram data onto said display surface using projection optics, the method further comprising encoding at least a portion of said projection optics into said hologram data.

11. A method as claimed in claim 10 wherein said projection optics is configured to give the appearance of said image being at a greater distance from an observer than said display surface.

12. A method as claimed in claim 9 further comprising quantising said hologram data, and wherein said projection comprises displaying said quantised hologram data on an illuminated spatial light modulator.

13. A method as claimed in claim 8 comprising generating a plurality of temporal holographic subframes for display in rapid succession such that corresponding temporal subframe images on said display surface average in an observer's eye to give the impression of said displayed image.

14. A method as claimed in claim 8 to provide head up display (HUD) for a vehicle, wherein said display surface comprises a windshield of said vehicle, the method comprising displaying an image holographically on said vehicle windshield.

15. A method as claimed in claim 14 further comprising storing, with said HUD, wavefront correction data for said optical aberration correcting for a shape of said vehicle windshield.

16. A method as claimed in claim 8 for providing a head up display (HUD) for a plurality of different vehicles having a plurality of differently shaped display surfaces using common display hardware, the method comprising providing said HUD by displaying an image holographically using the method of claim 8, the method further comprising for each vehicle, storing in said common display hardware wavefront correction data for optical aberration correcting specific to a shape of a said display surface of a respective vehicle in which said display hardware is to be used.

17. A method as claimed in claim 16 further comprising determining said wavefront correction data for each different shape of a said display surface using Zernike polynomials.

18. A carrier carrying processor control code to, when running, implement the method of claim 8.

19. A holographic image projection system to display an image holographically on a display surface, said display surface not being flat, the system comprising:
a spatial light modulator (SLM) to display a hologram;
an illumination system to illuminate said displayed hologram;
projection optics to project light from said illuminated displayed hologram onto said display surface to form said image; and
a processor having an input to receive image data for display and having an output for driving said SLM, and wherein said processor is configured to process said image data to generate hologram data for display on said SLM to form said image on said display surface;
the system further comprising a non-volatile data memory coupled to said processor to store wavefront correction data for said display surface; and
wherein said processor is configured to apply a wavefront correction responsive to said stored wavefront correction data when generating said hologram data to correct said image for aberration due to a shape of said display surface.

20. A method as claimed in claim 16 further comprising determining said wavefront correction data for each different shape of a said display surface using Seidel functions.
